(19) United States
(12) Patent Application Publication
(10) Pub. No.: US 2008/0104010 A1
(43) Pub. Date: May 1, 2008

(54) Configuring initialized RFID readers using RFID tags

(75) Inventors: P.V. Subramanian, Frederick, MD (US); Ajay Avasthi, Potomac, MD (US); Sangita Patel, Campbell, CA (US); Steven Zimmerman, Minnetonka, MN (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/589,922

(22) Filed: Oct. 31, 2006

(51) Int. Cl. G06F 17/30

(52) U.S. Cl. 707/1; 340/572.1; 340/10.1

(57) ABSTRACT

Methods, systems, and apparatuses for configuring a radio frequency identification (RFID) reader using an RFID tag are described. A RFID tag is read by the reader to obtain reader configuration information from the RFID tag. A registry of the reader is modified to include the reader configuration information. A management system is communicated with by the reader, based on information obtained by the reader in the reader configuration information. The reader is thereby configured for operation.

### BACKGROUND OF THE INVENTION

1. Field of the Invention

The present invention relates to wireless communications, and more particularly, to radio frequency identification (RFID) communication systems including RFID readers that communicate with RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

With the maturation of RFID technology, efficient communications between tags and readers has become a key enabler in supply chain management, especially in manufacturing, shipping, and retail industries, as well as in building security installations, healthcare facilities, libraries, airports, warehouses etc.

The growing proliferation of RFID readers in the supply chain creates an environment with large numbers of readers in a given site installation. Aside from the physical installation, reader deployment typically requires an educated technician equipped with a computer to configure the reader. Even an educated technician can enter an incorrect configuration, causing a malfunctioning network device that must be subsequently revisited in order to set an accurate configuration.

Thus, what is needed are improved ways of configuring readers at installation sites, while reducing the number of incorrect reader configurations.

### BRIEF SUMMARY OF THE INVENTION

Methods, systems, and apparatuses for configuring RFID readers are described. In an aspect of the present invention, an initialized reader communicates with an RFID tag to obtain configuration information for the reader. The configuration information provides the reader with a management system's location and provides access credentials in order to be fully configured for an operational environment (e.g., a production environment).

In an aspect of the present invention, a radio frequency identification (RFID) reader is configured using an RFID tag. A RFID tag is read by the reader to obtain reader configuration information from the RFID tag. A registry of the reader is modified to include the obtained reader configuration information. The reader communicates with a management system based on information obtained in the reader configuration information. In this manner, the reader configured for operation.

In a further aspect, the reader may receive additional configuration from the management system during the communications with the management system.

In another aspect of the present invention, a radio frequency identification (REID) tag is enabled to configure a RFID reader. A configuration signal is received at the tag that includes reader configuration information. In example aspect, the reader configuration information may include one or more of a management system address, a reader identification number, login information for a management system, and/or site identification information. The reader configuration information is stored in the tag.

In another aspect of the present invention, a radio frequency identification (RFID) tag is provided. The tag includes an electronic circuit that includes a memory and a transceiver configured to communicate with a reader. The memory stores reader configuration information.

In a further aspect, the electronic circuit further includes a write lock flag. The write lock flag can be set by a reader to lock the reader configuration information from being altered.

In a further aspect of the present invention, a radio frequency identification (RFID) device for configuring a RFID tag is provided. The RFID device includes a storage module, a transceiver, and a tag configure module. The storage module stores reader configuration information. The tag configure module is configured to enable the transceiver to transmit a configuration signal that includes the reader configuration information. A tag receives the configuration signal, and stores the reader configuration information.

In a still further aspect of the present invention, a radio frequency identification (RFID) reader is described. The reader includes a tag communication module, a registry, and a registry modify module. The tag communication module is configured to read information from a RFID tag, the information including reader configuration information stored by the RFID tag. The registry modify module is configured to modify the registry to include the received reader configuration information.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIG. 3 shows a block diagram of an example radio frequency identification (RFID) tag.

FIG. 4 shows a flowchart providing example steps for configuring a reader, according to an example embodiment of the present invention.

FIG. 5 shows a reader configuration system, according to an embodiment of the present invention.

FIG. 6 shows a block diagram of a tag, according to an example embodiment of the present invention.

FIG. 7 shows an example of reader configuration information, according to embodiments of the present invention.

FIG. 8 shows a block diagram of a reader, according to an example embodiment of the present invention.

FIG. 9 shows a block diagram of a reader communicating with an RFID management system, according to an embodiment of the present invention.

FIG. 10 shows a detailed block diagram of a communication between a reader and management system, according to an example embodiment of the present invention.

FIG. 11 shows a flowchart providing example steps for configuring a reader, according to another example embodiment of the present invention.

FIG. 12 shows a flowchart providing example steps for configuring a tag, according to another example embodiment of the present invention.

FIG. 13 which shows an example system for configuring a tag, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

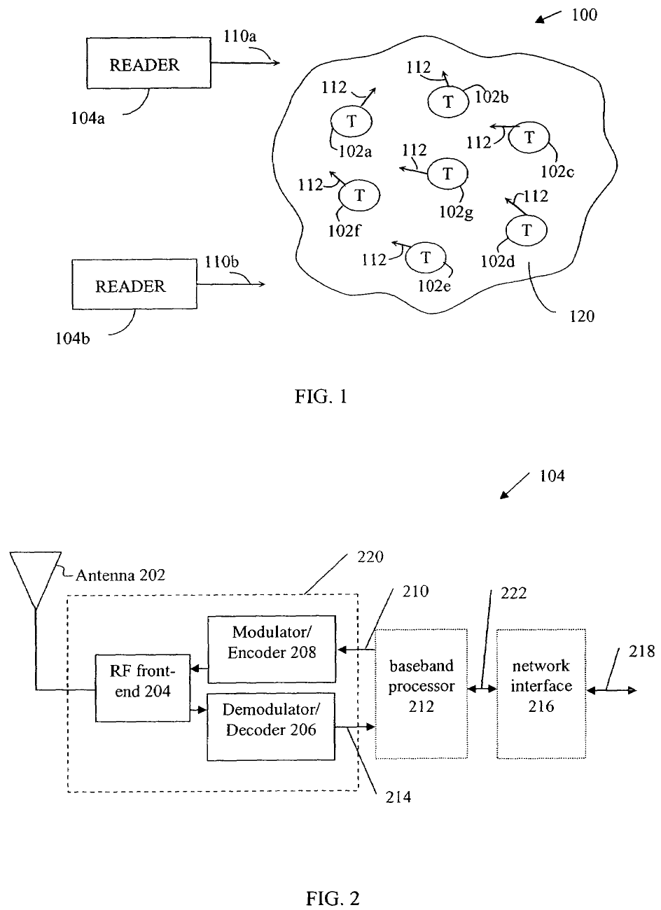

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

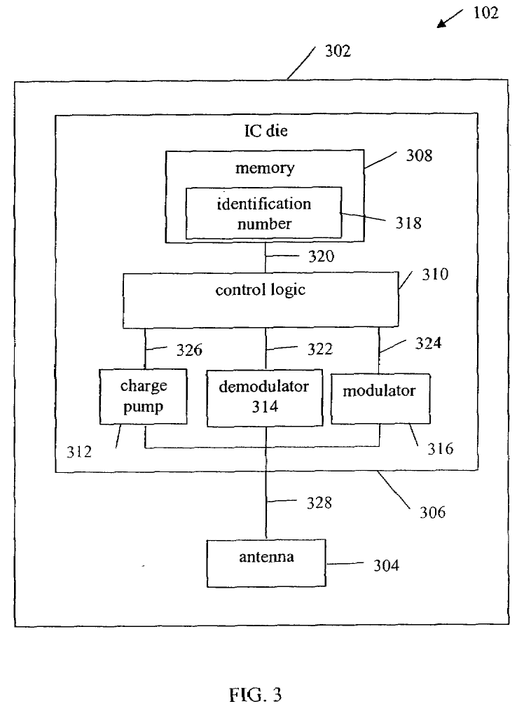

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Example embodiments of the present invention are described in further detail below. Such embodiments may be implemented in the environments, readers, and tags described above, and/or in alternative environments and alternative RFID devices.

### Example Embodiments

Methods, systems, and apparatuses for configuring RFID readers are described. In an embodiment, a reader communicates with an RFID tag to obtain configuration information for the reader. The reader is thus enabled to communicate with a management system, such as for a reader network, to obtain further configuration information (if needed), to register with the management system, and to thereby begin an operation of reading tags. In another embodiment, an RFID device is used to configure the RFID tag, to load the tag with the reader configuration information. These embodiments can be implemented in any types of RFID tags, readers, and other RFID devices, including those described above and otherwise known. Furthermore, embodiments provide for rapid deployment of readers, in an automated fashion, and with fewer configuration errors with respect to conventional ways of deploying readers.

The example embodiments described herein are provided for illustrative purposes, and are not limiting. The examples described herein may be adapted to any type of tag and reader. Further structural and operational embodiments, including modifications/alterations, will become apparent to persons skilled in the relevant art(s) from the teachings herein.

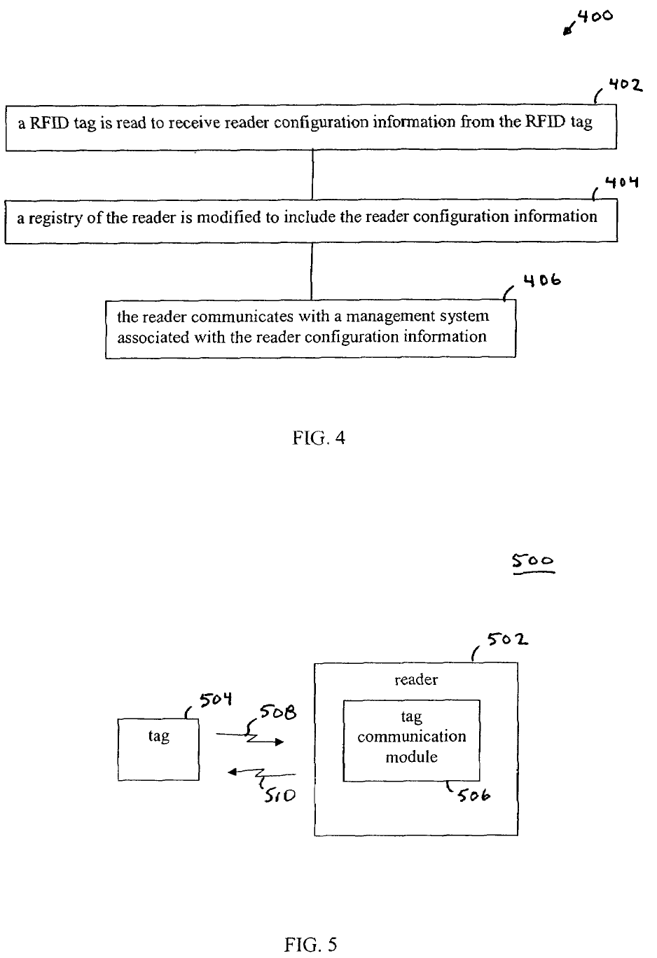

For example, FIG. 4 shows a flowchart 400 providing example steps for configuring a reader, according to an example embodiment of the present invention. Other structural and operational embodiments will be apparent to persons skilled in the relevant art(s) based on the following discussion. For illustrative purposes, the steps of flowchart 400 are described in detail below with regard to FIGS. 5-10, which show example RFID environments in which the process of flowchart 400 may be implemented.

Flowchart 400 begins with step 402. In step 402, a RFID tag is read to receive reader configuration information from the RFID tag. For example, FIG. 5 shows a reader configuration system 500, according to an embodiment of the present invention. As shown in FIG. 5, a reader 502 communicates with a tag 504 using a tag communication module 506. Tag communication module 506 is configured to communicate with RFID tags. For example, tag communication module 506 may include a modulator, demodulator, antenna, and/or other communications elements for communicating with tags, such as those described above with regard to FIG. 2 or otherwise known. Reader 502 transmits a read signal 508 to tag 504. Read signal 508 may be any suitable type of signal for reading tags, including interrogation signal 110 described above, and may be configured according to an suitable communication protocol, including any of those mentioned elsewhere herein.

Tag 504 transmits a response signal 510 to reader 502, in response to read signal 508. Response signal 510 includes reader configuration information, as is further described below. Although response signal 510 is shown in FIG. 5 as a single response signal for illustrative purposes, response signal 510 may include a plurality of responses signals transmitted by tag 504, in response to one or more read signals 508 from reader 502, to obtain the reader configuration information.

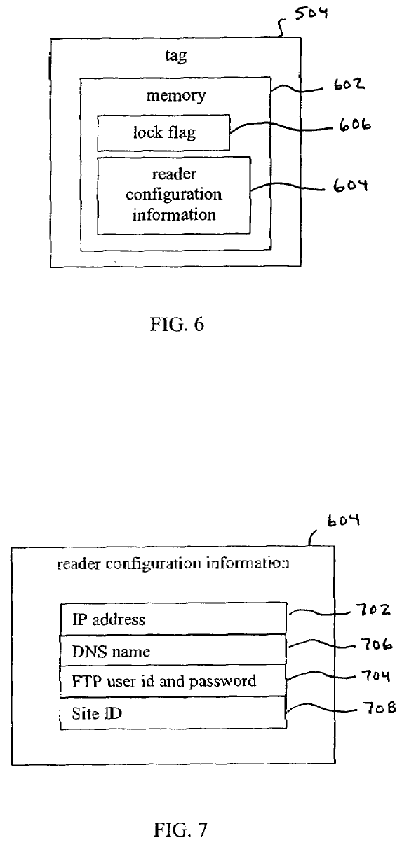

FIG. 6 shows a block diagram of tag 504, according to an example embodiment of the present invention. As shown in FIG. 6, tag 504 includes a memory 602, which may be configured similarly to memory 308 described above with respect to FIG. 3, or may be configured otherwise. Memory 602 includes reader configuration information 604 and a lock flag 606. Tag 504 may include further elements, such as shown above for tag 102 in FIG. 3. However, these elements are not shown or described with respect to FIG. 6 for reasons of brevity.

Reader configuration information 604 includes any number of one or more data or information elements that may be used to configure a reader, such as reader 502, to interact with a management system. In embodiments, reader configuration information 604 enables the reader to communicate with the management system, such as to register with the management system, to obtain any additional configuration and/or network information that may be needed, and/or to thereby operate to read RFID tags in a vicinity of the reader. Reader configuration information 604 may be stored in tag 504 in an encrypted or non-encrypted manner. Lock flag 606 is optionally present. Lock flag 606 may be set or reset to lock or unlock reader configuration information 604 in memory 602, to protect reader configuration information 604 for being overwritten, in desired. Further description of lock flag 606 is provided further below.

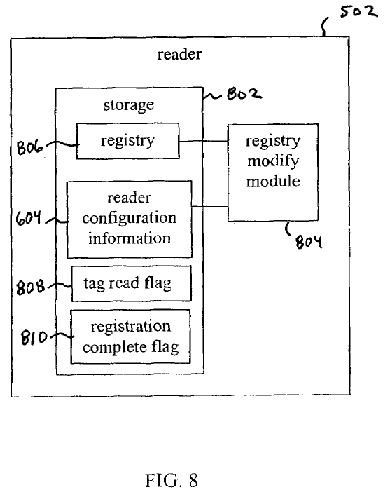

FIG. 7 shows an example of reader configuration information 604, according to embodiments of the present invention. In the example of FIG. 7, reader configuration information 604 includes an IP (internet protocol) address 702 of the management system and/or a DNS (domain name system) name 706, an FTP (file transfer protocol) user ID and password 704, and a site ID 708. In embodiments, reader configuration information 604 may include any one or more of these data elements shown in FIG. 7. In another embodiments, reader configuration information 604 may include alternative data elements other than those shown in FIG. 7.

In an embodiment, reader configuration information 604 includes IP address 702, as shown in FIG. 7. IP address 702 is an IP address for a management system that reader 502 may desire to communicate with, as described above. In an alternative embodiment, IP address 702 may be an address in a format for a network protocol other than IP, for example DNS name 706, as would be known to persons skilled in the relevant art(s).

In an embodiment, reader configuration information 604 includes FTP user ID and password 704, as shown in FIG. 7. FTP user ID and password 704 may be used to enable reader 502 to login to the management system, or other desired system. In this manner, reader 502 may be able to access information of the management system (or other system). In an alternative embodiment, FTP user ID and password 704 may be an ID and password for an alternative application other than FTP, as would be known to persons skilled in the relevant art(s).

In an embodiment, reader configuration information 604 includes site ID 708, as shown in FIG. 7. Site ID 708 may be an alphanumeric (or other format) identifier that can be used to group readers. For example, site ID 708 may be a name (e.g., understandable by a human and/or computer) of a reader group that is to include reader 502. In an alternative embodiment, site ID 708 may be an identifier for an entity other than a group of readers, such as a location in a building, a management system name, or other entity identifier, as would be understood by persons skilled in the relevant art(s).

Thus, according to step 402 shown in FIG. 4, reader 502 may read tag 504 (as shown in FIG. 5) to receive reader configuration information 604 (shown in FIG. 6). FIG. 8 shows a block diagram of reader 502, according to an example embodiment of the present invention. In FIG. 8, reader 502 stores reader configuration information 604 read from tag 504 in a storage 802. Storage 802 may be any type of storage for reader 502, permanent or removable, including one or more memory devices, magnetic storage devices, optical storage devices, etc., or any combination thereof, as would be understood by persons skilled in the relevant art(s).

In step 404 of flowchart 400 shown in FIG. 4, a registry of the reader is modified to include the reader configuration information. For example, in an embodiment, reader 502 enters reader configuration information 604 in a registry of reader 502. FIG. 8 shows reader 502 including a registry modify module 804. Furthermore, in the embodiment of FIG. 8, storage 802 includes a registry 806, a tag read flag 808, and a registration complete flag 810. Reader 502 may include further elements, such as shown above for reader 104 in FIG. 2. However, these elements are not shown or described with respect to FIG. 8 for reasons of brevity. Tag read flag 808 and registration complete flag 810 are optional, and are described in detail further below.

Registry 806 may be present in reader 502 as a database storing settings and options for reader 502, such as an address for reader 502, etc. According to step 404, registry modify module 804 updates registry 806 of reader 502 to include information of reader configuration information 604. For example, registry update module 804 may enter IP address 702 or DNS name 706 from reader configuration information 604 into registry 806. In this manner, reader 502 is updated to have an address of a management system, or other entity, with which reader 502 may desire to communicate. Registry update module 804 may enter FTP user ID and password 704 from reader configuration information 604 into registry 806. In this manner, reader 502 is updated to have login information for a management system, or other entity, with which reader 502 may exchange information. Registry update module 804 may enter site ID 708 from reader configuration information 604 into registry 806. In this manner, reader 502 is updated to have a site identifier.

Registry update module 804 may be implemented in hardware, software, firmware, or any combination thereof, as would be understood by persons skilled in the relevant art(s). For example, in an embodiment, registry update module 804 may be implemented in baseband processor 212, shown in FIG. 2, or other location.

Thus, according to step 404 shown in FIG. 4, registry 806 of reader 502 is modified to enter reader configuration information 604.

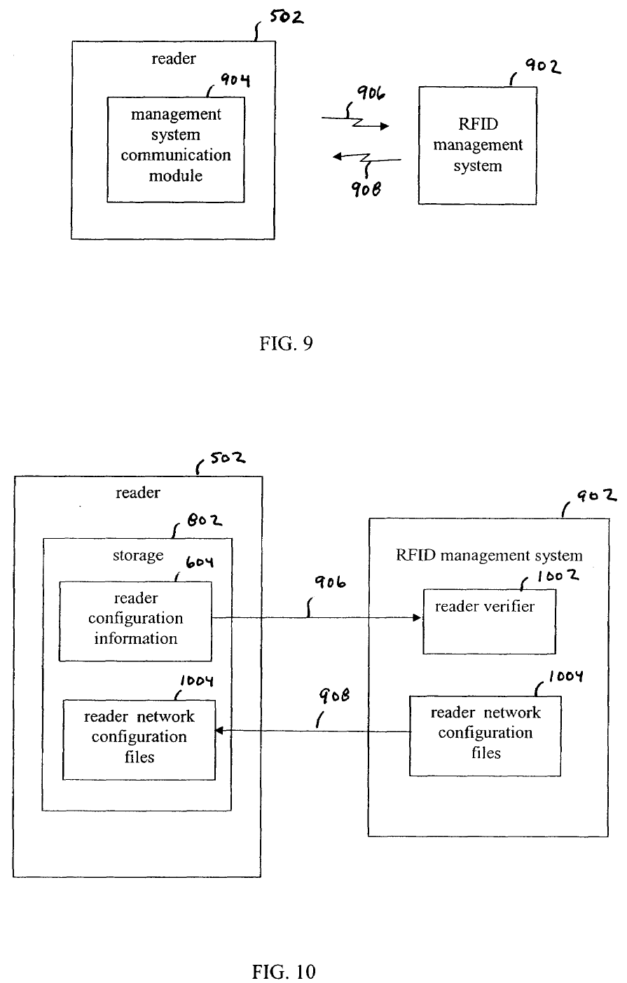

In step 406, the reader communicates with a management system associated with the reader configuration information. For example, FIG. 9 shows a block diagram of reader 502 communicating with an RFID management system 902, according to an embodiment of the present invention. Reader 502 includes a management system communication module 904 configured to communicate with management system 902. For example, management system communication module 904 may include any suitable communications elements for communicating with management system 902, such as network interface 216 described above with regard to FIG. 2, or other communication elements. Management system communication module 904 may be configured to communicate with management system 902 in a wired or wireless fashion. For example, reader 502 and management system 902 may be coupled together in a network, such as a DHCP (dynamic host configuration protocol) type network.

Reader 502 transmits a first communication signal 906 to management system 902. For example, first communication signal 906 may be used by reader 502 to establish communications with management system 908, using information received in reader configuration information 604. For example, FIG. 10 shows a more detailed block diagram of a communication between reader 502 and management system 902. As shown in FIG. 10, reader 502 transmits first communication signal 906 to management system 902, based at least in part on reader configuration information 604 (which may be present in registry 806 of reader 502). For instance, reader 502 uses IP address 702 or DNS name 706 obtained in reader configuration information 604 as an address for management system 902 in first communication signal 906. Reader 502 may transmit FTP user ID and password 704 in first communication signal 906 to log into management system 902, to exchange data with management system 902. Reader 502 may provide additional and/or alternative information to management system 902 in first communication signal 906, based at least in part on the contents of reader configuration information 604.

As shown in FIG. 10, in an embodiment, management system 902 may include a verifier module 1002. Verifier module 1002 may be used by management system 902 to verify information provided by reader 502 in first communication signal 906, such as an address provided by reader 502, to verify and approve (or reject) reader 502 for operation as a reader in a network managed by management system 902. Verifier module 1002 may be implemented in hardware, software, firmware, or any combination thereof, as would be understood by persons skilled in the relevant art(s).

Management system 908 transmits a second communication signal 908 to reader 502, in response to first communication signal 906. Second communication signal 908 may include a variety of information. For example, second communication signal 908 may be an acknowledgement of first communication signal 908, including an acknowledgement of a registration of reader 502 with management system 902. Second communication signal 906 may provide an indication to reader 502 that information supplied by reader 502 in first communication signal 908 is verified, and that reader 502 is approved for a network managed by management system 902.

Furthermore, in an embodiment, management system 902 provides reader 502 with additional configuration information in second communication signal 908. For example, as shown in FIG. 10, management system 902 may provide reader network configuration files 1004 to reader 502 in second communication signal 908. For example, one or more network configuration files 1004 may be provided to reader 502 using any suitable communication mechanism, including FTP or TFTP (trivial FTP) file transfer protocols and/or files 1004 may be transferred in an encrypted or unencrypted manner. Information in network configuration files 1004 may be used by reader 502 to further configure reader 502 for use in its local environment. For example, files 1004 may provide information regarding other readers in a vicinity of reader 502 so that reader 502 can communicate in a manner to avoid interference with the other readers. In another example, files 1004 provide information to reader 502 to tune parameters of a receiver and/or transmitter (e.g., a transceiver) of reader 502 for improved communications in a local environment of reader 502.

In an embodiment, management system 902 stores information on one or more types of readers, including reader 502. After reader 502 establishes communications with management system 902, management system 902 identifies reader 502 (for example, verifier module 1002 may identify a type of reader 502). Management system 902 may look up information regarding the identified type of reader 502, such as in a reader profile table. In this manner, management system 902 can provide reader-type specific information in network configuration files 1004 to reader 502, to improve/optimize performance of reader 502.

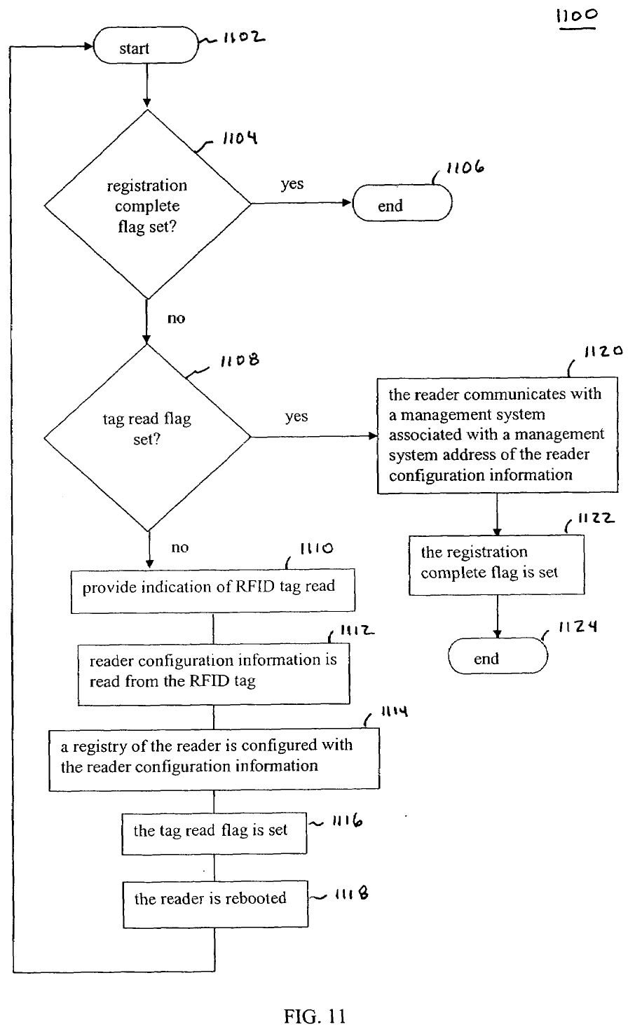

Tag 504, reader 502, and management system 902 can interact in a variety of ways to configure reader 502 for operation in an RFID environment, in more detailed processes than described above with regard to FIG. 4, depending on the particular application. For example, FIG. 11 shows a flowchart 1100 providing example steps for configuring a reader, according to another example embodiment of the present invention. Other structural and operational embodiments will be apparent to persons skilled in the relevant art(s) based on the following discussion. The steps of flowchart 1100 are described in detail below.

Flowchart 1100 begins with step 1102. In step 1102, the reader configuration process starts. For example, reader 502 may be powered up in an RFID network for the first time, reader 502 may be rebooted, reader 502 may be initialized, or an alternative event may occur to start the process of flowchart 1100 at step 1102.

In decision step 1104, the reader determines whether a registration complete flag is set. For example, the registration complete flag may be registration complete flag 810 shown in FIG. 8 for reader 502. Registration complete flag 810 indicates whether registry 806 of reader 502 has been updated with reader configuration information 604, and reader 502 has communicated with management system 902. If registration complete flag 810 indicates that registration is complete, operation proceeds to step 1106, where operation of flowchart 1100 ends. If registration complete flag 810 does not indicate that registration is complete, operation proceeds to step 1108.

In decision step 1108, the reader determines whether a tag read flag is set. For example, the tag read flag may be tag read flag 808 shown in FIG. 8 for reader 502. Tag read flag 808 indicates whether reader configuration information 604 has been read from a tag, such as tag 504. If tag read flag 808 indicates that reader configuration information 604 has been read from a tag, operation proceeds to step 1120. If tag read flag 808 indicates that reader configuration information 604 has not been read from a tag, operation proceeds to step 1110.

In step 1110, an indication is provided that a tag read is being conducted. For example, reader 502 may provide an indication to an operator of reader 502, or a technician installing reader 502, that a read of a tag, such as tag 504, is being performed to obtain reader configuration 604. Reader 502 may provide this indication with an output device of a user interface of reader 502, such as by flashing an LED, providing a sound output, displaying alphanumeric text or graphics in a display, etc. By providing this indication, it will be apparent that reader 502 is performing a configuration process.

In step 1112, reader configuration information is read from the RFID tag. For example, step 1112 may be performed in a similar manner as described above for step 402 of flowchart 400 shown in FIG. 4.

In step 1114, a registry of the reader is configured with the reader configuration information. For example, step 1114 may be performed in a similar manner as described above for step 404 of flowchart 400 shown in FIG. 4.

In step 1116, a tag read flag is set. For instance, in an embodiment, tag read flag 808 of reader 502 is set. Setting tag read flag 808 indicates that a tag, such as tag 504, has been read, and reader configuration information 604 has been obtained and entered into registry 806 (or other suitable location) of reader 502.

In step 1118, the reader is rebooted. For example, reader 502 may be rebooted to restart. In this manner, reader configuration information 604 in the updated registry 806 of reader 502 will be become active as reader 502 powers up and initializes. Operation proceeds back to step 1102.

In step 1120, the reader communicates with a management system associated with a management system address of the reader configuration information. For example, as described above, reader configuration information 604 may include IP address 702, which may be an address of management system 902. Reader 502 is enabled to communicate with management stem 902 due to having received IP address 702 in reader configuration information 604. Step 1120 may be performed in a similar manner as described above for step 406 of flowchart 400 in FIG. 4.

In step 1124, the registration complete flag is set. For example, in an embodiment, registration complete flag 810 is set. Setting registration complete flag 810 indicates that reader 502 has been configured by a tag, such as tag 504, has registered with management system 902. Thus, in an embodiment, at this point, reader 502 is ready for operation (e.g., to begin interrogating tags in a communication range of reader 502). Operation proceeds to step 1124, where operation of flowchart 1100 ends.

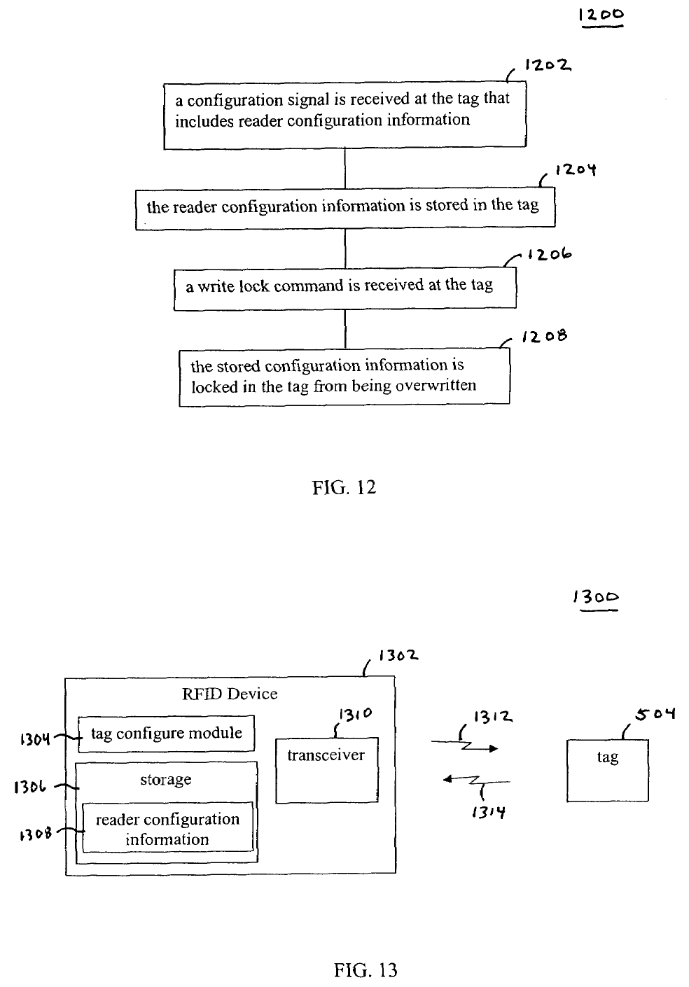

In embodiments, tag 504 may be configured with reader configuration information 604 to be used to configure reader 502 as described above. For example, FIG. 12 shows a flowchart 1200 providing example steps for configuring a tag, according to another example embodiment of the present invention. Other structural and operational embodiments will be apparent to persons skilled in the relevant art(s) based on the following discussion. For illustrative purposes, the steps of flowchart 1200 are described in detail below with regard to FIG. 13, which shows an example system 1300 for configuring tag 504.

Flowchart 1200 begins with step 1202. In step 1202, a configuration signal is received at the tag that includes reader configuration information. For instance, FIG. 13 shows system 1300, where RFID device 1302 communicates with tag 504, according to an example embodiment of the present invention. RFID device 1302 is configured to load tag 504 with reader configuration information. As shown in the example of FIG. 13, RFID device 1302 includes a tag configure module 1304, a storage 1306, and a transceiver 1310. Storage 1306 includes reader configuration information 1308.

Tag configure module 1304 includes logic for configuring tag 504 with reader configuration information 1308. Tag configure module 1304 may be implemented in hardware, software, firmware, or any combination thereof, as would be understood by persons skilled in the relevant art(s). Storage 1306 may be any type of storage for RFID device 1302, permanent or removable, including one or more memory devices, magnetic storage devices, optical storage devices, etc., or any combination thereof, as would be understood by persons skilled in the relevant art(s). RFID device 1302 may be any type of RFID communication system, including a reader, a tag programmer, or other RFID device, mobile or stationary.

Tag configure module 1304 directs transceiver 1310 to transmit a first communication signal 1312 to tag 504, where first communication signal 1312 includes reader configuration information 1312. Although first communication signal 1312 is shown in FIG. 13 as a single signal for illustrative purposes, first communication signal 1312 may include a plurality of signals transmitted by RFID device 1302, to provide reader configuration information 1308 to tag 504. Transceiver 1310 may be any suitable type of transceiver, as described elsewhere herein or otherwise known.

In step 1204, the reader configuration information is stored in the tag. For example, tag 504 stores reader configuration 1308 in memory, such as shown in FIG. 6, where tag 504 stores reader configuration 604 in memory 602. In FIG. 13, tag 504 transmits an optional second communication signal 1314 to RFID device 1302. Second communication signal 1314 may be used to confirm whether reader configuration information 1308 was successfully stored in tag 504, and/or for other purposes.

In step 1206, a write lock command is received at the tag. Step 1206 is optional. In an embodiment, RFID device 1302 may transmit a write lock command to tag 504, to cause tag to lock the reader configuration information stored in tag 504. In this manner, the reader configuration information cannot be altered without a write unlock command being received by tag 504 from RFID device 1302 or other device.

In step 1208, the stored information is locked in the tag from being overwritten. Step 1208 is optional. For example, as shown in FIG. 6, memory 602 of tag 504 may include lock flag 606. Lock flag 606 may be a single bit, or other number of bits, or memory 602. Lock flag 606 is set to indicate that reader configuration information 604 (and optionally further portions of memory 602) is write locked. Lock flag 606 may be subsequently reset to indicate that reader configuration information 604 is not write locked.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a reader may execute computer-readable instructions to communicate with a tag to receive configuration information, and to communicate with a server to register with the server as described above. Furthermore, the server may execute computer-readable instructions to communicate with the reader, and to process information related to the reader communications. Still further, an RFID device may execute computer-readable instructions to communicate with a tag, to enable the tag to configure a reader, as described above.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1-20. (canceled)

21. A current controller comprising:
a first transistor having a first terminal connected to a power supply voltage and a second terminal connected to the gate of the first transistor;
a second transistor having a first terminal connected to the power supply voltage and a second terminal adapted to output a set current pulse, and a gate connected to the gate of the first transistor; and
a control transistor having a first terminal connected to the second terminal of the first transistor and a second terminal connected to a ground voltage, wherein the function of the control transistor is determined by at least a set voltage pulse applied to the gate of the control transistor.

22-24. (canceled)

25. A write driver circuit including the current controller of claim 21.

26. The current controller of claim 21, wherein the current controller is adapted to apply the set current pulse to a plurality of phase-change cells.

27. The current controller of claim 21, wherein the set current pulse includes a plurality of stages in which a magnitude of the set current pulse is gradually decreased.

28. The current controller of claim 27, wherein the plurality of stages includes at least a first through an nth stages, where n is greater than or equal to two.

29. The current controller of claim 28, wherein the magnitude of the set current pulse of the first stage corresponds to a maximum current for transitioning a phase-change cell to the set resistance state.

30. The current controller of claim 28, wherein the magnitude of the set current pulse of the first stage does not exceed a magnitude of current for heating a plurality of phase-change cells to their melting temperature.

31. The current controller of claim 27, wherein the plurality of stages includes stages during which the magnitude of the set current pulse is zero.

32. The current controller of claim 27, wherein the plurality of stages are sequentially generated.

33. The current controller of claim 27, wherein the plurality of stages includes four stages.

34. The current controller of claim 21, wherein the set voltage pulse has first through nth stages, where n is greater than or equal to two, in which a magnitude of voltage is gradually decreased.

35. The current controller of claim 34, wherein the magnitude of the set voltage pulse of the first stage corresponds to a maximum voltage for a phase-change cell that requires a maximum current to transition to a set resistance state.

36. The current controller of claim 34, wherein the magnitude of the set voltage pulse of the first stage does not exceed a voltage required to generate a set current pulse for heating a plurality of phase-change cells to their melting temperature.

37. The current controller of claim 34, wherein the plurality of stages includes stages during which the magnitude of the set current pulse is zero.

38. The current controller of claim 34, wherein the first to nth stages are sequentially generated.

39. The current controller of claim 27, wherein n is four.
